(19) United States
(12) Patent Application Publication
(10) Pub. No.: US 2019/0261076 A1
(43) Pub. Date: Aug. 22, 2019

(54) METHODS AND APPARATUS RELATING TO DATA TRANSFER OVER A USB CONNECTOR

(71) Applicant: Cirrus Logic International Semiconductor Ltd., Edinburgh (GB)

(72) Inventors: Bradley Allan LAMBERT, Austin, TX (US); Michael Allan KOST, Cedar Park, TX (US); Robert David RAND, Peebles (GB); Ian Johnson SMITH, Rosewell (GB)

(73) Assignee: Cirrus Logic International Semiconductor Ltd., Edinburgh (GB)

(21) Appl. No.: 16/279,148

(22) Filed: Feb. 19, 2019

Related U.S. Application Data
(60) Provisional application No. 62/632,699, filed on Feb. 20, 2018.

(51) Int. Cl. H04R 1/08; G10L 25/78; H04R 3/00; G06F 13/42

(52) U.S. Cl. CPC H04R 1/083; G10L 25/78; G06F 2213/0042; G06F 13/4282; H04R 2420/09; H04R 3/00

(57) ABSTRACT

There is provided a USB audio accessory device, comprising: an audio transducer, configured to generate an audio transducer signal; interface circuitry, configured to receive analogue and digital representations of the audio transducer signal; and a USB-C connector for connecting to a USB host device, coupled to the interface circuitry. The interface circuitry is operable, in a first mode of operation, to output simultaneously the analogue representation of the audio transducer signal over a first pin of the USB-C connector, and the digital representation of the audio transducer signal over second and third pins of the USB-C connector.

### TECHNICAL FIELD

Embodiments of the disclosure relate to methods and apparatus for data transfer via data connectors, and particularly via Universal Serial Bus (USB) connectors.

### BACKGROUND

Users of electronic devices are increasingly using their voice as an input to control those devices. The user's voice is captured by one or more transducers (e.g., microphones) of the electronic device and processed to determine the presence of a command, and the command is then executed. Execution of the command may be dependent on authorization of the user, e.g., by biometric authentication of the voice input.

In order to reduce power consumption, electronic devices will frequently operate in a standby, sleep or other low-power mode when not in active use. In the context of voice input, such a low-power mode may be implemented using what is known as “always-on processing”. This requires the user to speak a predetermined keyword (or key phrase) in order to wake the device from its low-power mode. Well-known examples include “Hey Siri” and “OK Google”. A low-power processor is configured to receive the voice input and detect only the keyword. Once the keyword is detected, the electronic device wakes to a higher-power mode, and analyses the voice input for any command phrases which may have followed.

Peripheral or accessory devices are commonly used in conjunction with electronic devices, to provide audio output to the user via one or more speakers, and to receive audio input via one or more microphones. For example, headsets generally comprise both one or more speakers and one or more microphones for that purpose. Thus the voice input, used to control the electronic device as described above, may be detected by an accessory device which is coupled to the electronic device (also called the “host device” herein).

A problem thus arises when a user seeks to wake their electronic device from a low-power state using voice input through an accessory device. The voice input should be processed in a way which consumes little power, while providing acceptable quality.

One approach to this problem places supplemental signal processing in the accessory device, and uses an all-digital interface between the accessory device and the host device. Thus the transducer signal generated in the accessory device is processed (e.g., for always-on processing) in the accessory device. The disadvantage of this approach is that placing supplemental signal processing in the accessory makes the accessory device significantly more expensive. The accessory device must substantially duplicate the signal processing located in the host device in order to maintain a user experience similar to the host device. This means that the accessory device should be as readily updatable as typical host systems, and the accessory device must also include advanced digital-signal processors. Both updateability and signal processing significantly complicate the accessory design.

If the transducer signal is to be output from the accessory device to the host device for processing, one approach is to provide a digital link between the accessory device and the host device, and to leave the digital link active while the accessory or host is in the low-power mode. The digitized transducer signal may thus be sent to the host device over the digital link for processing by the host device. Although this solution allows digital-only accessories to send a digitized transducer signal to a host for signal processing, the result is unacceptably high power for most portable host systems (e.g., mobile phone).

Other existing solutions use an analogue link to send transducer signals from the accessory device to the host device. The most basic example is a purely analogue headset. Some systems have combined digital and analogue signaling by switching the interface between the host and accessory from a purely digital link to a purely analogue link. This presents a number of challenges that the prior art fails to solve. First, the physical transport (i.e., connector, host internal signal routing, and cabling) results in poor transducer signal quality due to cross coupling and noise. Second, the analogue link requires at least one signal pin per transducer signal, so multiple transducer accessories must use multiple contacts in the physical interface. This use of multiple contacts is problematic when USB-C is the transport because USB SuperSpeed signals are sensitive to the parasitic loading of the needed analogue switches. The presence of USB SuperSpeed on a USB Host effectively limits the number of repurpose-able pins of the USB-C interface to two or three pins.

Other systems use transducers integrated into the host for supplemental signal processing features like always-on-voice while audio accessories are connected. These systems are typically limited by the positioning of transducers located in the host device. Specifically, it is common for users to leave portable host devices in a position or location that is obscured from the user's voice while accessories like headphones are attached, so the transducers located in the host cannot be effectively used for supplemental signal processing.

### SUMMARY

Embodiments of the present disclosure seek to address these and other problems.

For example, in one aspect there is provided a USB audio accessory device, comprising: an audio transducer, configured to generate an audio transducer signal; interface circuitry, configured to receive analogue and digital representations of the audio transducer signal; and a USB-C connector for connecting to a USB host device, coupled to the interface circuitry. The interface circuitry is operable, in a first mode of operation, to output simultaneously the analogue representation of the audio transducer signal over a first pin of the USB-C connector, and the digital representation of the audio transducer signal over second and third pins of the USB-C connector.

A further aspect provides a USB host device, comprising: a USB-C connector, connectable to a USB audio accessory device; and processing circuitry, coupled to the USB-C connector. The processing circuitry is operative to receive simultaneously from the USB audio accessory device an analogue representation of an audio transducer signal over a first pin of the USB-C connector, and a digital representation of the audio transducer signal over second and third pins of the USB-C connector. The processing circuitry is operative to selectively process a selected one of the analogue and digital representations of the audio transducer signal.

Another aspect provides a method for processing an analogue transducer signal through a USB-C connector, comprising: receiving the analogue transducer signal via one or more pins of the USB-C connector; receiving a digital representation of the analogue transducer signal through a digital link over at least two pins of the USB-C connector. A USB-C host coupled to a USB-C connector selectively processes at least one of the analogue transducer signal and the digital representation of the analogue transducer signal to achieve low power consumption for USB-C communication.

A hybrid analog-digital interface for a USB-C-based audio accessory and host is described. The interface carries an analogue transducer signal or signals and a digital interface over the same connector at the same time. Herein the interface is described as a hybrid analog-digital interface because it carries both an analogue transducer signal and the equivalent digitized transducer signal over a single connector.

The phrase “supplemental processing” is used herein to mean the processing of an audio signal for the detection of audio which is meaningful to the USB Host. Such audio may comprise a spoken input of a user, such as a keyword, keyphrase or a command, a song or other input which can be detected and used to provide information to applications running in the USB to improve the user experience (e.g., detecting one or more songs and recommending similar or related songs for future playback, detecting an external environment or context of the USB Host based on audio and providing information relevant for that environment, etc). In particular embodiments, supplemental processing may be performed while the USB Host is in a low-power state (e.g., a sleep mode).

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 shows a system according to embodiments of the disclosure;

FIG. 2 shows a system according to further embodiments of the disclosure;

FIG. 3 shows an accessory assembly according to embodiments of the disclosure;

FIG. 4 shows a host assembly according to embodiments of the disclosure; and

FIG. 5 is a flowchart of a method in a host assembly according to embodiments of the disclosure.

### DETAILED DESCRIPTION

The description below sets forth example embodiments according to this disclosure. Further example embodiments and implementations will be apparent to those having ordinary skill in the art. Further, those having ordinary skill in the art will recognize that various equivalent techniques may be applied in lieu of, or in conjunction with, the embodiments discussed below, and all such equivalents should be deemed as being encompassed by the present disclosure.

An interface for a USB-C-based audio accessory and host is described. The interface carries an analogue transducer signal or signals and the equivalent digitized transducer signal over the same connector at the same time, and thus may be described herein as a hybrid analog-digital interface.

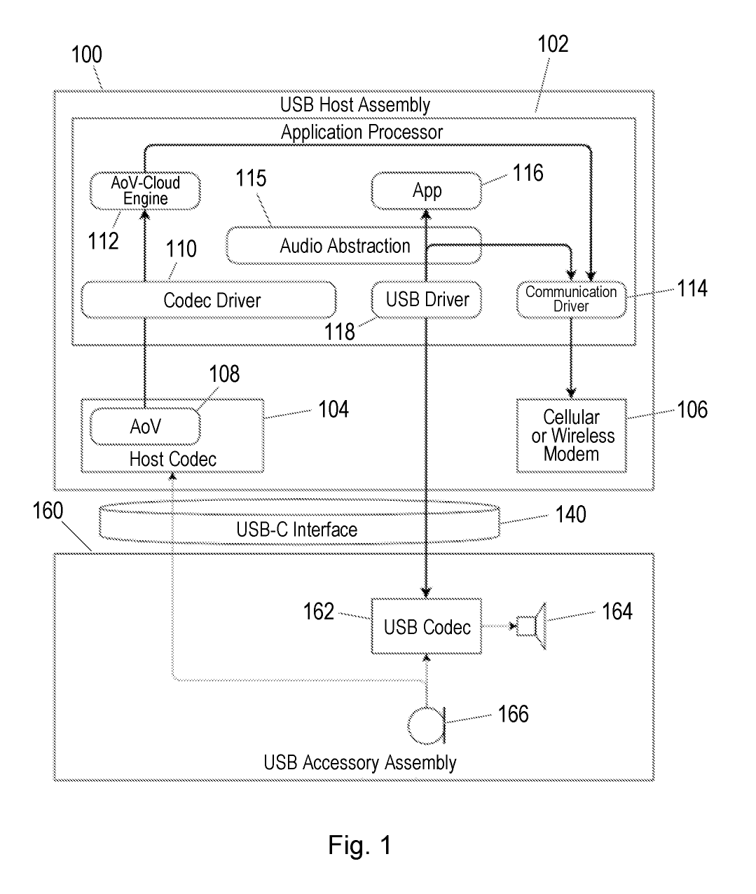

FIG. 1 is a block diagram of a system according to embodiments of the disclosure comprising a USB Host Assembly 100 (e.g., a mobile phone or other portable electronic device), a USB-C Interface 140, and a USB Accessory Assembly 160 (e.g., a peripheral device such as a headset). The USB-C Interface 140 may couple an analogue transducer signal and a bidirectional digital interface between the USB Host Assembly 100 and the USB Accessory Assembly 160 as shown in FIG. 1.

The USB Host Assembly 100 comprises an Application Processor 102, a Host Codec 104, and a Cellular or Wireless Modem 106. In the illustrated embodiment, the Host Codec 104 and the Modem 106 are each coupled to the Application Processor 102.

The USB Accessory Assembly 160 comprises a USB Codec 162, an output transducer 164 (e.g., a speaker), and an input transducer 166 (e.g., a microphone). In the illustrated embodiment, the input transducer 166 is coupled to the USB-C interface 140 both directly and indirectly via the USB Codec 162. The output transducer 164 is coupled to the USB-C interface 140 through the USB Codec 162.

The Host Codec 104 receives an analogue transducer signal and contains, in the illustrated example, an always-on-voice (AoV) processor 108. The AoV processor 108 is configured to monitor the content of the analogue transducer signal and to detect the presence of a predetermined keyword or keyphrase which may be used to wake the USB Host Assembly 100 or the USB-C interface 140 from a low-power state. Those skilled in the art will appreciate that such AoV processing may alternatively be performed in any suitable component of the USB Host Assembly 100 other than the Codec 104 (e.g. Application Processor 102).

The output of the AoV processor 108 is coupled to always-on-voice-Cloud Engine (AoV-Cloud Engine) 112, via a codec driver 110. The output of the AoV-Cloud Engine 112 is coupled to a Communication Driver 114, which is in turn coupled to the modem 106. The AoV Cloud Engine 112 may be a software driver that takes data (e.g., voice data, comprising a predetermined keyword or keyphrase, and potentially one or more commands) from the Codec Driver 110 and sends it to a remote computing environment (e.g., the cloud) for further processing. Thus data is received from the codec driver 110 as illustrated in FIG. 1. Data is sent to the remote computing environment via the connection between the AoV Cloud Engine 112 and the Communication Driver 114. Those skilled in the art will appreciate that voice command processing may rely on processing both in the local device (e.g., USB Host Assembly 100, Application Processor 102) and the remote computing environment.

In FIG. 1, the USB Codec 162 of the USB Accessory Assembly 160 is coupled to an application (App) 116 running in the Application Processor 102, and to the Communication Driver 114 through a digital link traversing the USB-C interface 140 and a USB Driver 118 (which may also be running in the application processor 102). The Communication Driver 114 may be coupled to the Modem 106.

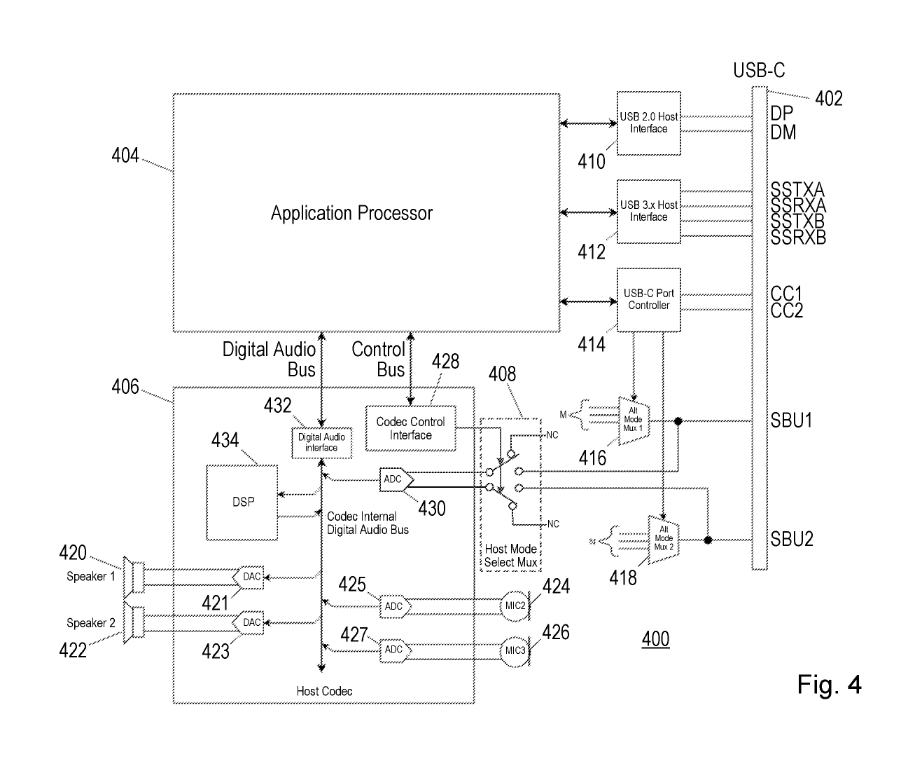

The USB Accessory Assembly 160 further comprises an Audio Abstraction processing module 115, which may alternatively be called a Hardware Abstraction Layer (HAL). The Audio Abstraction processing module 115 enables the App 116 to send audio to either the Host Codec 104 or the USB Accessory Assembly 160. For example, in Android® systems, the Audio Abstraction is called Audio HAL and it will render audio to the Host Codec 104 or the USB Accessory Assembly 160 based on a currently active use case. In some embodiments of the present disclosure, however, use of the Audio Abstraction processing module 115 is circumvented by keeping the processing of audio at lower layers (which typically consume less power than the Audio Abstraction processing module). See, for example, the processing shown in FIG. 4.

The USB Host Assembly 100, and particularly the AoV processor 108, processes the input analogue transducer signal for always-on-voice supplemental signal processing (e.g., to detect the presence of a predetermined keyword or keyphrase, or some other audio which is relevant or meaningful to the USB Host Assembly 100). The USB Host Assembly 100 also transmits and receives digitized transducer signals over a digital link.

The USB Accessory Assembly 160, and particularly the USB codec 162, processes input analogue transducer signals (e.g., generated by the input transducer 166) to create a digitized transducer signal, transmits and receives digitized transducer signals over a digital link, and processes output digital transducer signals (e.g., received via the digital link over the USB-C interface 140) to create an analogue output transducer signal for output by the output transducer 164. The USB Accessory Assembly 160 further transmits an analogue transducer signal to the USB Host Assembly 100, in accordance with embodiments of the present disclosure.

The example embodiment illustrated in FIG. 1 may represent a mobile phone (i.e., the USB Host Assembly 100) coupled to a headset (i.e., the USB Accessory Assembly 160) while a phone call is active and voice command input is active. A communication application 116 running within the Application Processor 102 implements the phone call processing through digital signal input and output via the bidirectional digital link between the USB Host Assembly 100 and the USB Accessory Assembly 160. Always-on-voice processing (AoV) running within the Host Codec 104 implements the voice command input processing using an analogue transducer signal from the USB Accessory Assembly 160 connected to the USB Host Assembly 100.

Thus both analogue and digital representations of the input transducer signal are provided to the USB Host Assembly 100 via the USB-C interface 140. Operating the accessory in a hybrid analog-digital mode has at least four advantages over existing solutions. First, the digitized transducer signal is higher fidelity than an analog-only interface because the digital interface is not degraded by connectors and switches in the same manner as an analogue transducer signal. Second, a host implementation is lower in cost and complexity than an analog-only interface because fewer analogue signals are required, and polarity detection or switching can be simplified or eliminated. Third, the analogue portion of the interface may remain operational while the digital interface is in a low power state. This allows a significant reduction in host and accessory power when the accessory or host is in a standby state. Fourth, the host may apply digital signal processing to the received analogue transducer signal even if the accessory contains no digital signal processor.

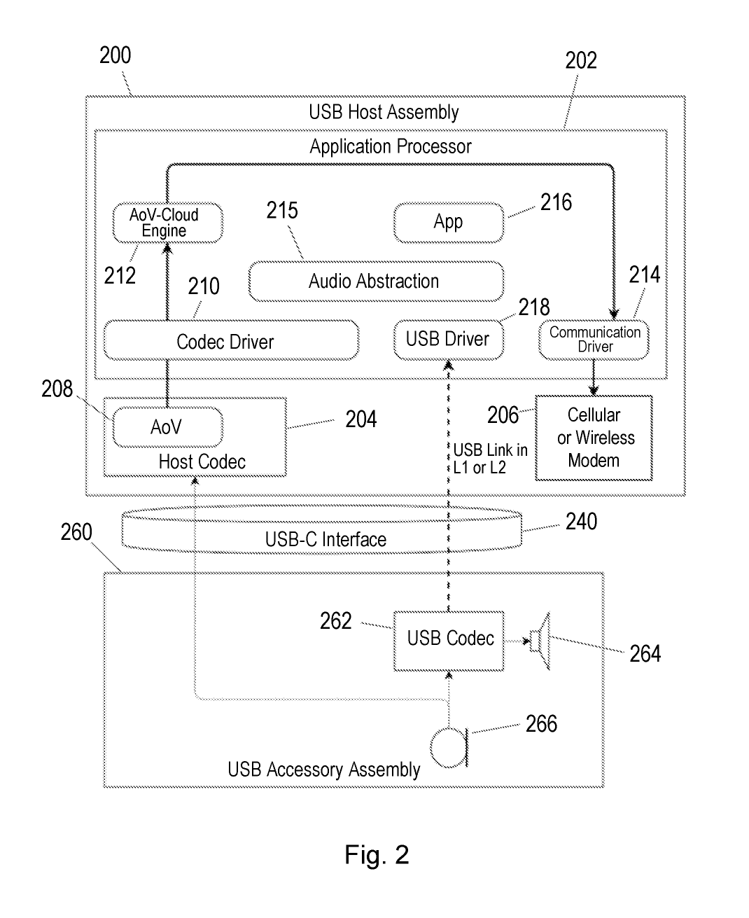

FIG. 2 illustrates an example high level block diagram having a USB Host Assembly 200, a USB-C Interface 240, and a USB Accessory Assembly 260, in accordance with embodiments of the present disclosure. The components illustrated in FIG. 2 are similar to FIG. 1. The connections illustrated in FIG. 2 are also similar to FIG. 1, except that the digital link may be in a non-operational, low power mode (e.g., USB L1, USB Sleep, USB L2, or USB Suspend), and therefore a connection need not exist among the USB Driver 218, the App 216, or the Communication Driver 214.

In this manner, the embodiment shown in FIG. 2 may correspond to the same hardware as shown in FIG. 1, but in a different mode of operation. In this mode of operation, the USB Accessory Assembly 260 transmits the analogue transducer signal to the host codec 204, while the digital link is maintained in a non-operational, low power mode. The USB Host Assembly 200 processes the input analogue transducer signal for always-on-voice supplemental processing (e.g., in the AoV processor 208).

The example embodiment illustrated in FIG. 2 may represent a mobile phone coupled to a headset while no media playback or recording is active and voice command input is active. Thus, the analogue transducer signal is utilized for always-on processing, while the digital link can be in a low-power mode.

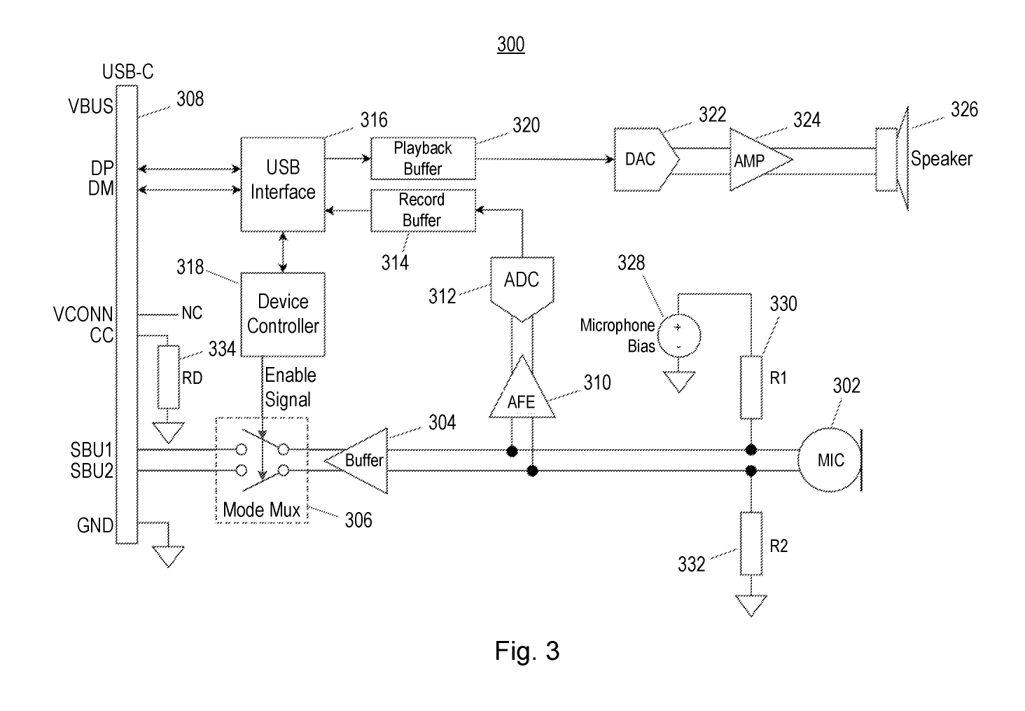

FIG. 3 illustrates a USB Accessory Assembly 300 in accordance with embodiments of the present disclosure. The USB Accessory Assembly 300 may correspond to either or both of the USB Accessory Assemblies 160, 260 described above.

The USB Accessory Assembly 300 comprises a microphone (“MIC”) 302 connected to both an analogue front end (“AFE”) 310 and a buffer (“Buffer”) 304. The microphone 302 generates an analogue input transducer signal (e.g., in a differential signal configuration) and outputs the signal to the AFE 310 and the buffer 304.

Also illustrated is biasing circuitry for applying a bias voltage to the microphone 302. Thus a microphone bias circuit 328 (e.g., a reference voltage or current source) is coupled to one electrode of the microphone 302 via a first resistor 330; the other electrode of the microphone 302 is coupled to ground via a second resistor 332.

The buffer 304 may have an input to output transfer function of unity, attenuation, or gain. The output of the buffer 304 is connected to a mode multiplex switch (“Mode Mux”) 306. The mode multiplex switch 306 may include a pair of switches with a common control input. The mode multiplex switch 306 may have two states controlled by an enable signal (“Enable Signal”): high impedance (Hi-Z); or enabled.

The output of the AFE 310 is connected to an analog-to-digital converter (“ADC”) 312, which converts the analogue input transducer signal to the digital domain. The ADC 312 thus outputs a digital representation of the analogue input transducer signal.

The output of the ADC 312 is connected to a record digital sample buffer (“Record Buffer”) 314, which stores the digital representation of the analogue input transducer signal. The output of the record digital sample buffer 314 is connected to a USB interface 316, which controls the transmission of the digital representation of the analogue input transducer signal via a USB-C connector 308 (e.g., to a host device assembly). Thus, in the illustrated embodiment, a bidirectional USB data input/output of the USB interface 316 is connected to USB data pins (“DP” and “DM”) of the USB-C connector 308.

The USB Accessory Assembly 300 is operative to receive control signals from the USB Host Device, e.g., via the digital link of the USB-C connector 308 over USB data pins or via different pins of the USB-C connector 308. The USB interface 316 is thus operative to receive the control signals and control the mode of operation of the US Accessory Assembly 300 in dependence on those control signals. In this context, as described above and in more detail below, the mode of operation may correspond to the output of different combinations of analogue and digital representations of the input transducer signal over the USB-C connector 308.

In the illustrated embodiment, a bidirectional control signal(s) input/output of the USB interface 316 is connected to a device controller 318. The enable signal output of the device controller 318 is connected to the mode multiplex switch state control.

In one embodiment, when the hybrid analog-digital interface mode is active (i.e., both analogue and digital representations of the input transducer signal are output over the USB-C connector 308) the mode multiplex switch 306 is enabled; otherwise, the mode multiplex switch 306 may be high impedance.

Those skilled in the art will appreciate that the mode multiplex switch 306 shown is one example embodiment of the disclosure. Additional mode multiplexing is possible where the hybrid analog-digital interface is one possible interface configuration out of a plurality of supported alternative interface configurations.

In the illustrated embodiment, the output of the mode multiplex switch 306 is connected to two repurpose-able pins (“SBU1” and “SBU2”) of the USB-C connector 308. It should be appreciated that the example embodiment uses the SBU1 and SBU2 pins; however, these are not the only repurpose-able pins of a USB-C interface. Any other suitable repurpose-able pins of the USB-C connector 308 may be used.

An example playback- or speaker-path is also shown in FIG. 3. Thus an audio output of the USB interface 316 is connected to a playback digital sample buffer (“Playback Buffer”) 320. The output of the playback digital sample buffer 320 is connected to a digital-to-analogue converter (“DAC”) 322 which converts the digital output audio signal to the analogue domain, and outputs the analogue signal to a speaker (“Speaker”) or similar audio transducer via an amplifier 324. Of course, the example playback-path shown is one embodiment of the disclosure. It will be appreciated that the playback path may be stereo or multi-channel in nature.

Additional USB-specific interface details are also shown in FIG. 3. The Vconn pin (“VCONN”) and Vbus pin (“VBUS”) are shown not connected within the USB accessory assembly 300. It should be appreciated that components of the USB accessory assembly 300 may sink power from the Vbus pin, the Vconn pin, both, or neither.

The CC pin (“CC”) of the USB-C interface 308 is shown connected to a pull-down resistor (“RD”) 334 as one possible embodiment of the present disclosure. It should be appreciated that the USB Accessory Assembly 300 may implement a USB-PD interface connected to a CC pin of the USB interface.

FIG. 4 illustrates a USB Host Assembly 400 according to embodiments of the disclosure. The USB Host Assembly 400 may correspond to either or both of the USB Host Assemblies 100, 200 described above. The USB Host Assembly 400 may connect to the USB Accessory Assembly 300 described above with respect to FIG. 3.

In the illustrated embodiment, the USB Host Assembly 400 comprises a USB-C connector (USB-C) 402, an Application Processor 404, a Host Codec 406 and a Host Mode Select Multiplexer (Host Mode Select Mux) 408. The USB Host Assembly 400 additionally comprises a first alternate mode multiplexer (Alt Mode Mux 1) 416, a second alternate mode multiplexer (Alt Mode Mux 2) 418, a USB-C Port Controller 414, a USB 3.x Host Interface 412, a USB2.0 Host Interface 410, two microphone transducers (MIC2 and MIC3) 424, 426, and two speaker transducers (Speaker 1 and Speaker 2) 420, 422.

The USB 2.0 Host Interface 410 may connect to DP and DM pins of USB-C connector 402 and may connect to Application Processor 404.

The USB 3.x Host Interface 412 may connect to SSTXA, SSTXB, SSRXA, and SSRXB pins of the USB-C connector 402 and may connect to Application Processor 404.

The USB-C Port Controller 414 may connect to CC1 and CC2 pins of the USB-C connector 402 and may connect to Application Processor 404. The USB-C Port Controller 414 may further connect to a control input of the first Alternate Mode Multiplexer 416 and a control input of the second Alternate Mode Multiplexer 418.

The SBU1 pin of the USB-C connector 402 may connect to the first Alternate Mode Multiplexer 416 and a first input of the Host Mode Select Multiplexer assembly 408. The SBU 2 pin of the USB-C connector 402 may connect to the second Alternate Mode Multiplexer 418 and a second input of the Host Mode Select Multiplexer assembly 408. Again, those skilled in the art will appreciate that the SBU1 and SBU2 pins are not the only repurpose-able pins of a USB-C interface. Any other suitable repurpose-able pins of the USB-C interface may be used.

It will further be appreciated that the separate Host Mode Select Multiplexer 408, first Alternate Mode Multiplexer 416, and second Alternate Mode Multiplexer 418 illustrated in FIG. 4 may be combined into a single connection multiplexer, two alternate mode multiplexers, or any equivalent signal routing assembly.

The outputs of the first Alternate Mode Multiplexer 416 (labeled M) and the second Alternate Mode Multiplexer 418 (labeled N) are omitted for clarity. In one embodiment, the outputs of the first Alternate Mode Multiplexer 416 and the second Alternate Mode Multiplexer 418 are not active while an analogue transducer signal is coupled to repurpose-able pin or pins of the USB-C interface in accordance with embodiments of the present disclosure.

The Host Mode Select Multiplexer assembly 408 may comprise first and second switches each coupled respectively to first and second inputs, and to an alternative input. The alternative inputs of the Host Mode Select Multiplexer assembly 408 may be not connected (NC) such that when alternative inputs are selected, the outputs of the Host Mode Select Multiplexer assembly 408 (i.e., the first input and the second input) are high-impedance. In alternative embodiments, the alternative inputs of the Host Mode Select Multiplexer assembly 408 may be connected to a microphone, or analogue transducer within the USB Host Assembly 400 such that while the hybrid analog-digital interface is not active, a microphone, or analogue transducer within USB Host Assembly is coupled to an Analog-to-Digital Converter (ADC) input of the Host Codec. The output of the Host Mode Select Multiplexer assembly 408 may be connected to an input of an ADC 430 in the Host Codec 406.

A Codec Control Interface 428 of the Host Codec 406 may connect to the Host Mode Select Multiplexer assembly 408 such that the first and second switches of the Host Mode Select Multiplexer assembly 408 are responsive to a control signal output by the Codec Control Interface 428. The Codec Control Interface 428 may be further coupled to the Application Processor 404 via a control bus, such that the control signals output to the Host Mode Select Multiplexer assembly 408 by the Codec Control Interface 428 correspond to, or are dependent on, control signals output from the Application Processor 404 to the Codec Control Interface 428. Those skilled in the art will appreciate that the source of the control signal for the Host Mode Select Multiplexer assembly 408 may be the Host Codec 406, a suitable output of the Application Processor 404, the USB-C Port Controller 414, or another component of the USB Host Assembly 400.

The Host Codec 406 may further be connected to first and second speaker transducers 420, 422 and microphone transducers 424, 426 through a Digital Audio Bus.

The Host Codec 406 may further comprise one or more ADCs 425, 427 (e.g., coupled to the first and second microphones 424, 426), one or more DACs (e.g., coupled to the first and second speakers 420, 422), a Digital-Signal Processor (DSP) 434, an Internal Digital Audio Bus and a Digital Audio Interface 432 as shown in FIG. 4, in accordance with embodiments of the present disclosure.

In the illustrated embodiment, the digital link (e.g., as shown in FIG. 1 and FIG. 2) propagates from the Application processor 404 to the USB 2.0 Host Interface 410 to DP and DM pins of the USB-C connector 402. When combined with the USB Accessory Assembly 300 described above with respect to FIG. 3, the digital link thus terminates in the USB Interface 316.

An analogue transducer signal (e.g., as shown in FIG. 1 and FIG. 2) propagates from SBU1 and SBU2 pins of the USB-C connector 402 to the Host Mode Select Multiplexer Assembly 408 and onto an ADC input 430 of the Host Codec 406. Thus, when the Host Mode Select Multiplexer Assembly 408 is controlled such that the first and second switches output to the HADC 430, the Host Codec 408 receives the analogue transducer signal generated by the microphone 302 and transmitted via the USB-C connectors 308, 402.

In the illustrated embodiment, supplemental processing of the analogue transducer signal occurs in the DSP 434 of the Host Codec 406 (which may therefore correspond to the AoV processor 108, 208 described above). The results or outputs of the supplemental processing may be propagated to the Application processor 404 through the Digital Audio Bus, the Control Bus, or a combination of both.

It should be noted that the analogue transducer signal path described in the example embodiment is independent of the digital link such that the analogue transducer signal path may be enabled without the digital link and the digital link may be enabled without the analogue transducer signal path, and both paths may be enabled simultaneously, according to the selected mode of operation.

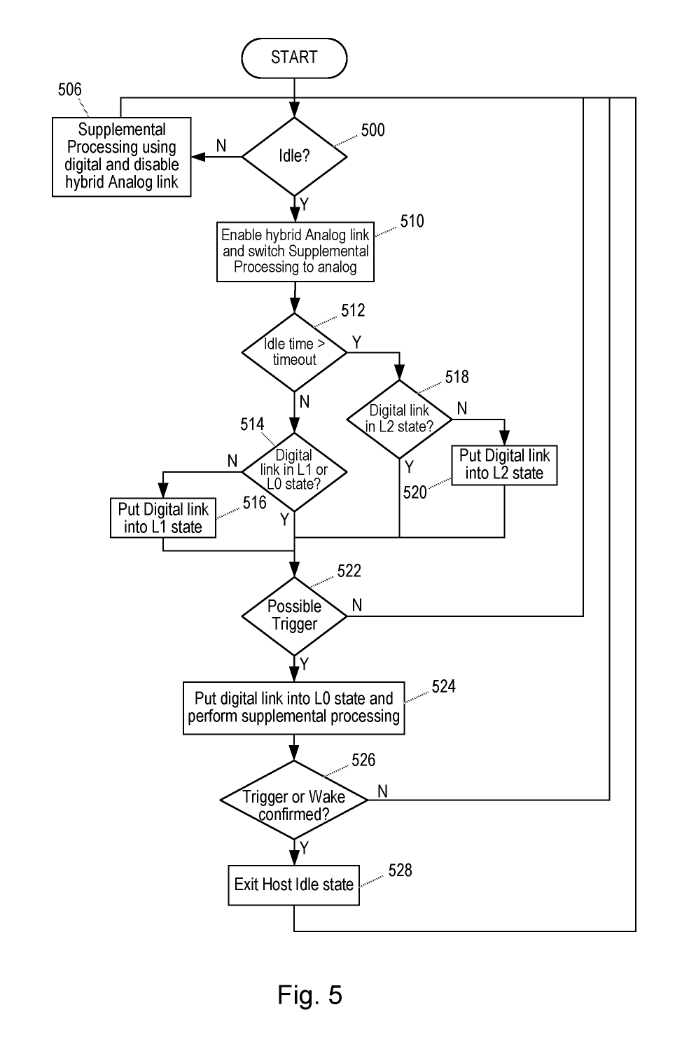

FIG. 5 is a flowchart of a method according to embodiments of the disclosure. The method may be performed, for example, in any of the processing circuitry of the USB Host Assemblies 100, 200, 400 described above, such as the Application Processors 102, 202, 404.

The method begins when both digital and analogue representations of the transducer signal are transmitted over the data interface from the USB Accessory Assembly to the USB Host Assembly. The processing circuitry thus receives a digital representation of the transducer signal. The analogue representation of the transducer signal may also be received by the processing circuitry, or by different circuitry within the USB Host Assembly (e.g., a Codec).

The method begins in step 500, in which the processing circuitry determines whether the digital link (e.g., that link which—in the illustrated embodiments—propagates via the DP and DM pins of the USB-C connectors) is idle or not. In some embodiments, a determination that the digital link is idle means that no audio playback and no audio recording is occurring between the USB Host and the USB Accessory. One way to detect this is by checking if both render and capture streams over the digital link are in what is called “Alternate Setting Zero” or the zero bandwidth configuration. If the digital link is not idle, then the link must be in an active mode (e.g., L0). If the digital link is in the active mode, supplemental processing is performed based on the digital representation of the transducer signal (step 506). The analogue link via the USB-C connectors may be disabled (e.g., by suitable control of the Host Mode Select Mux Assembly 408). The processing circuitry may utilize the results of the supplemental processing to perform one or more operations, such as playback of the transducer signal, a phone call (e.g., transmission of the transducer signal contents via the Modem 106, 206), etc.

If the digital link is determined to be idle in step 500, the method proceeds to step 510 in which the supplemental processing is performed based on the analogue representation of the transducer signal. Thus the analogue link via the USB-C connectors is enabled, or remains enabled (e.g., by suitable control of the Host Mode Select Mux Assembly 408). The DSP 434 may thus perform supplemental signal processing based on the analogue representation of the transducer signal.

Power may thus be saved in the USB Host Assembly by moving the digital link to a lower power state when supplemental signal processing is performed based on the analogue transducer signal. In step 512, the processing circuitry determines whether the digital link has been idle for a time interval which is greater than a predetermined time-out interval. If the digital link has not been idle for that long a time interval, the method proceeds to step 514 in which the processing circuitry determines whether the digital link is in an intermediate power mode (e.g., L1 state) or a low power mode (e.g., L2 state). If the digital link is in neither the intermediate power mode nor the low power mode, the digital link is put into the intermediate power mode in step 516 before proceeding to step 522. If the digital link is already in one of the intermediate power mode and the low power mode, the method proceeds directly to step 522. If it is determined in step 512 that the digital link has been idle for a time interval which is greater than the predetermined time-out interval, the method proceeds to step 518 in which the processing circuitry determines whether the digital link is in the low-power mode (e.g., L2 state). If the digital link is not in the low-power mode, the digital link is put into that low-power mode in step 520 before proceeding to step 522. If the digital link is already in the low-power mode, the method proceeds directly to step 522.

In step 522, the processing circuitry determines whether a trigger has occurred. For example, the supplemental signal processing based on the analogue representation of the transducer signal may have detected the presence of a keyword or keyphrase uttered by a user, waking the USB Host Assembly from a low-power state. Alternatively, always-on processing may detect the presence of some other audio which is meaningful to the system, e.g., a particular song which can be identified and used by apps (e.g. app 116) to recommend similar or related songs for playback. If no trigger is detected, in the illustrated embodiment the method returns directly to step 500 to determine whether the digital link is idle or not.

If a trigger is detected, the method proceeds to step 526, in which the digital link is put into an active mode (e.g., L0 state) and the digital representation of the transducer signal is transferred from the USB Accessory Assembly via the digital link. Supplemental signal processing is then switched to the digital representation of the transducer signal. In particular, analysis of the digital representation transducer signal may be repeated in step 526 to re-detect the trigger which was detected in the analogue representation of the transducer signal. If the trigger is not confirmed, the method returns directly to step 500. If the trigger is confirmed, the processing circuitry wakes the USB Host Assembly from its idle or low-power state.

It should be understood—especially by those having ordinary skill in the art with the benefit of this disclosure—that the various operations described herein, particularly in connection with the figures, may be implemented by other circuitry or other hardware components. The order in which each operation of a given method is performed may be changed, and various elements of the systems illustrated herein may be added, reordered, combined, omitted, modified, etc. It is intended that this disclosure embrace all such modifications and changes and, accordingly, the above description should be regarded in an illustrative rather than a restrictive sense.

Similarly, although this disclosure makes reference to specific embodiments, certain modifications and changes can be made to those embodiments without departing from the scope and coverage of this disclosure. Moreover, any benefits, advantages, or solutions to problems that are described herein with regard to specific embodiments are not intended to be construed as a critical, required, or essential feature or element.

Further embodiments likewise, with the benefit of this disclosure, will be apparent to those having ordinary skill in the art, and such embodiments should be deemed as being encompassed herein.

For the avoidance of doubt, the following numbered statements set out embodiments of the disclosure:
1. A method for processing an analogue transducer signal through a USB-C connector, comprising:
   selectively coupling and sending the analogue transducer signal to one or more pins of the USB-C connector;
   sending a digital representation of the analogue transducer signal through a digital link over at least two pins of the USB-C connector;
   wherein a USB-C host coupled to a USB-C connector selectively processes at least one of the analogue transducer signal and the digital representation of the analogue transducer signal to achieve low power consumption for USB-C communication.
2. The method according to embodiment 1, wherein when the USB-C host selects the analogue transducer signal, the USB-C host selectively puts the digital link in a non-operative low power state so that low power consumption for USB-C communication is achieved.
3. The method according to embodiment 1, wherein the USB-C host uses the analogue transducer signal as an input for detection of at least one of voice for always-listening or always-on voice processing.
4. The method according to embodiment 1, wherein the USB-C host includes one or more switches to establish an analogue signal path between one or more pins of a USB-C connector and a host codec.
5. The method according to embodiment 4, wherein when the USB-C host selects the digital representation of the analogue transducer signal, the USB-C host disables the analogue signal path and host codec so that low power consumption for USB-C communication is achieved.
6. The method according to embodiment 1, wherein the digital representation is transmitted using a version of an USB Audio Class.
7. The method according to embodiment 1, wherein the digital representation is transmitted using a version of an USB Communication Device Class.
8. The method according to embodiment 7, wherein the USB-C host processes the analogue transducer signal to perform a first processing step and the USB-C host then processes the digital representation of the analogue transducer to perform a second processing step.
9. The method according to embodiment 8, wherein the digital link is in a non-operative low power state while the USB-C host performs the first processing step, and the second processing step is only initiated after a positive result of the first processing step.
10. The method according to embodiment 6, wherein the USB-C host processes the analogue transducer signal to perform a first processing step and the USB-C host then processes the digital representation of the analogue transducer to perform a second processing step.
11. The method according to embodiment 10, wherein the digital representation is transmitted in one or more transactions of maximum packet size such that transmission occurs faster than real time followed by one or more transactions of less than maximum packet size such that the transmission occurs equal to real time.
12. The method according to embodiment 10, wherein the digital link is in a non-operative low power state while the USB-C host performs the first processing step, and the second processing step is only initiated after a positive result of the first processing step.

1. A USB audio accessory device, comprising:
an audio transducer, configured to generate an audio transducer signal;
interface circuitry, configured to receive analogue and digital representations of the audio transducer signal; and
a USB-C connector for connecting to a USB host device, coupled to the interface circuitry; and
wherein the interface circuitry is operable, in a first mode of operation, to output simultaneously the analogue representation of the audio transducer signal over a first pin of the USB-C connector, and the digital representation of the audio transducer signal over second and third pins of the USB-C connector.

2. The USB audio accessory device according to claim 1, wherein the audio transducer comprises a microphone, and wherein the audio transducer signal comprises a voice signal from a user of the USB audio accessory device.

3. The USB audio accessory device according to claim 1, wherein the digital representation is output over the second and third pins of the USB-C connector in one or more transactions of maximum packet size such that transmission initially occurs at a rate which is faster than real time, followed by one or more transactions of less than maximum packet size such that the transmission subsequently occurs at a rate which is equal to real time.

4. The USB audio accessory device according to claim 1, wherein the interface circuitry is operable to select its mode of operation in dependence on a control signal received over the USB-C connector from the USB host device.

5. The USB audio accessory device according to claim 1, wherein the interface circuitry is further operable in a second mode of operation in which the analogue representation of the audio transducer signal is output over the first pin of the USB-C connector, and the digital representation of the audio transducer signal is not output over the second and third pins of the USB-C connector.

6. The USB audio accessory device according to claim 1, wherein the interface circuitry is further operable in a third mode of operation in which the digital representation of the audio transducer signal is output over the second and third pins of the USB-C connector, and the analogue representation of the audio transducer signal is not output over the first pin of the USB-C connector.

7. The USB audio accessory device according to claim 1, wherein the digital representation of the audio transducer signal is output over the USB-C connector in the first mode of operation using a version of an USB Audio Class or a version of an USB Communication Device Class.

8. A USB host device, comprising:
a USB-C connector, connectable to a USB audio accessory device; and
processing circuitry, coupled to the USB-C connector,
wherein the processing circuitry is operative to receive simultaneously from the USB audio accessory device an analogue representation of an audio transducer signal over a first pin of the USB-C connector, and a digital representation of the audio transducer signal over second and third pins of the USB-C connector, and
wherein the processing circuitry is operative to selectively process a selected one of the analogue and digital representations of the audio transducer signal.

9. The USB host device according to claim 8, wherein the processing circuitry is operative to select the analogue representation of the audio transducer signal as an input for detection of at least one of voice for always-listening or always-on voice processing.

10. The USB host device according to claim 9, wherein the processing circuitry is operative to select the digital representation of the audio transducer signal responsive to detection of a voice input using the analogue representation of the audio transducer signal

11. The USB host device according to claim 8, further comprising one or more switches to establish an analogue signal path between one or more pins of the USB-C connector and a host codec.

12. The USB host device according to claim 11, wherein the processing circuitry is operative to disable the analogue signal path and host codec responsive to selection of the digital representation of the audio transducer signal.

13. The USB host device according to claim 8, wherein the digital representation of the audio transducer signal is received using a version of a USB Audio Class or a version of a USB Communication Device Class.

14. The USB host device according to claim 8, wherein the processing circuitry is configured to process the analogue representation of the audio transducer signal to perform a first processing step and to process the digital representation of the audio transducer signal to perform a second processing step.

15. The USB host device according to claim 14, wherein the second processing step is initiated responsive to a positive result of the first processing step.

16. The USB host device according to claim 14, wherein a digital link over the second and third pins is in a non-operative low power state while the processing circuitry performs the first processing step.

17. The USB host device according to claim 8, wherein the digital representation is received over the second and third pins of the USB-C connector in one or more transactions of maximum packet size such that reception initially occurs at a rate which is faster than real time, followed by one or more transactions of less than maximum packet size such that the reception subsequently occurs at a rate which is equal to real time.

18. A method for processing an analogue transducer signal through a USB-C connector, comprising:
receiving the analogue transducer signal via one or more pins of the USB-C connector;
receiving a digital representation of the analogue transducer signal through a digital link over at least two pins of the USB-C connector;
wherein a USB-C host coupled to a USB-C connector selectively processes at least one of the analogue transducer signal and the digital representation of the analogue transducer signal to achieve low power consumption for USB-C communication.

19. The method according to claim 18, wherein the USB-C host processes the analogue transducer signal to perform a first processing step and the USB-C host then processes the digital representation of the analogue transducer to perform a second processing step.

20. The method according to claim 19, wherein the digital representation is received in one or more transactions of maximum packet size such that transmission occurs faster than real time followed by one or more transactions of less than maximum packet size such that the transmission occurs equal to real time.
